(19) United States
(12) Patent Application Publication
(10) Pub. No.: US 2012/0210821 A1
(43) Pub. Date: Aug. 23, 2012

(54) WIRE ACCESSIBLE HANDLEBAR WITH SHIELD COVER

(76) Inventor: Anthony J. Carlini, Santa Ana, CA (US)

(21) Appl. No.: 13/033,386

(22) Filed: Feb. 23, 2011

(51) Int. Cl. B62K 21/12

(52) U.S. Cl. 74/551.8

(57) ABSTRACT

A handlebar assembly is provided that includes a set of handlebars having one or more wiring channels formed along an outer surface of the handlebars. The channels may be adapted to receive and retain electrical wiring routed from the motorcycle switches to the triple tree. One or more protective coverings may be positioned over the channels and attached to the outer surface of the handlebars by fasteners to protect and retain the electrical wiring disposed in the wiring channels.

### BACKGROUND OF THE INVENTION

1. Field of the Invention

The present invention relates to a motorcycle handlebar, and in particular, to motorcycle handlebars having one or more channels for routing electrical wiring in the handlebars and protective coverings for enclosing the electrical wiring.

2. Related Art

Many biker enthusiasts upgrade various components of their motorcycle. One such component is the handlebar. Typically, the handlebar is formed from a single tube of tubular steel and bent in a suitable shape to provide the mounting location for the handgrips. The central section of the handlebar is secured to the top tree of the motorcycle with fasteners or via risers.

The handgrip areas of a handlebar are almost universally used for mounting controls including electrical switches for operating lights, horns and directional signals. The manual operating controls such as throttles and brakes usually have external cables. However, the electrical switches, which usually are small gauged wires that are relatively fragile, often have their insulated wires protected by threading or running through the interior of the handlebar tube from the handgrip regions and exiting the handlebar somewhere near the triple tree.

Threading the electrical wiring through the handlebars often times can be tedious and time consuming A need therefore exists for a handlebar assembly that provides easy installation of the electrical wiring while both protecting and insulating the wiring.

### SUMMARY

To address the above illustrated problems, a handlebar assembly is provided that includes a tubular member having an outer diameter, an interior, and a channel extending axially along at least a portion of the member, the channel extending inward from the outer diameter to the interior, and a protective covering detachably coupled to the outer diameter. The protective covering is configured to conform to the outer diameter of the handlebar and cooperate with the channel to define a passage for routing electrical wiring in the handlebar.

In addition, a set of handlebars for a mobile vehicle is provided. The handlebars may include a hollow tubular member having an outer diameter and an interior and a channel extending inward from the outer diameter into the interior. The channel may be formed along at least a portion of the tubular member.

A protective covering for a handlebar having at least one channel formed along an outer surface of handlebar is also provided. The protective covering may include an elongated slender body having an arcuate cross-section that conforms to outer surface of the handlebar. The protective covering is designed to be positioned over the channel

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a side view of a motorcycle including one example of one implementation of a handlebar assembly of the present invention.

FIG. 2A is a cross-sectional view of the handlebars of FIG. 1 taken along section line 2A-2A.

FIG. 2B is an exploded cross-sectional view of the handlebars of FIG. 1 taken along section line 2A-2A.

FIG. 3 is a partially exploded side view of a motorcycle including the handlebar assembly of FIG. 1.

FIG. 4 is a front view of one example of one implementation of an ape hanger style handlebar incorporating the handlebar assembly of the present invention.

FIG. 5 is an enlarged front view showing the grip portion of the handlebar of FIG. 5.

FIG. 6 is a side view of a motorcycle including another example of an implementation of a handlebar assembly of the present invention having protective shields attached along opposite sides of the handlebar.

FIG. 7A is a cross-sectional view of the handlebar of FIG. 6 taken along section line 7A-7A.

FIG. 7B is an exploded cross-sectional view of the handlebar of FIG. 6 taken along section line 7A-7A.

FIG. 8 is a partially exploded side view of a motorcycle including the handlebar assembly of FIG. 6.

FIG. 9A is a front view of an ape hanger style handlebar having protective shields attached along opposite sides of the handlebar.

FIG. 9B is a partial front view of the center bar region of the handlebar of FIG. 9A showing the electrical wiring being routed along the outside of the riser clamp.

FIG. 9C is a partial cross-sectional view of the center bar region of the handlebar of FIG. 9A showing the electrical wiring being routed through the center of the riser clamp.

FIG. 10 is a side view of a motorcycle including an example of an implementation of a handlebar assembly of the present invention where the length of the protective shield is shortened.

FIG. 11 is a partially exploded side view of a motorcycle including the handlebar assembly of FIG. 10.

FIG. 12 is side view of a protective shield of the present invention including an imprinted graphic design.

FIG. 13 is a cross-sectional view of a handlebar of the present invention having a plurality of diametrically arranged wiring channels.

FIG. 14 is a cross-sectional view of a handlebar of the present invention having a wiring channel with a square-shaped cross-section.

FIG. 15 is a cross-sectional view of a handlebar of the present invention having an opening for threading electrical wiring through the handlebar interior.

FIG. 16 is a partial cross-sectional view of a handlebar of the present invention having a taper in the wiring channel in a region proximal the middle of the center bar.

FIG. 17 is a partial top view of the center bar region of the handlebar of FIG. 16.

FIG. 18 is a side view of a handlebar of the present invention having wiring channels that diametrically converge in the center bar region.

FIG. 19 is a front view of the handlebar of FIG. 18.

FIG. 20 is a cross-sectional view of the handlebar of FIG. 18 taken along section line 20-20 in FIG. 19.

FIG. 21 is a cross-sectional view of the handlebar of FIG. 18 taken along section line 21-21 in FIG. 19.

FIG. 22 is a cross-sectional view of the handlebar of FIG. 18 taken along section line 22-22 in FIG. 19.

FIG. 23 is a partial bottom view of the handlebar of FIG. 18 showing a central region of the center bar.

FIG. 24 is a side view of a motorcycle including one example of a set of cruiser-style handlebars including one implementation of a handlebar assembly of the present invention.

FIG. 25 is a partially exploded side view of a motorcycle including the handlebar assembly of FIG. 24.

### DETAILED DESCRIPTION

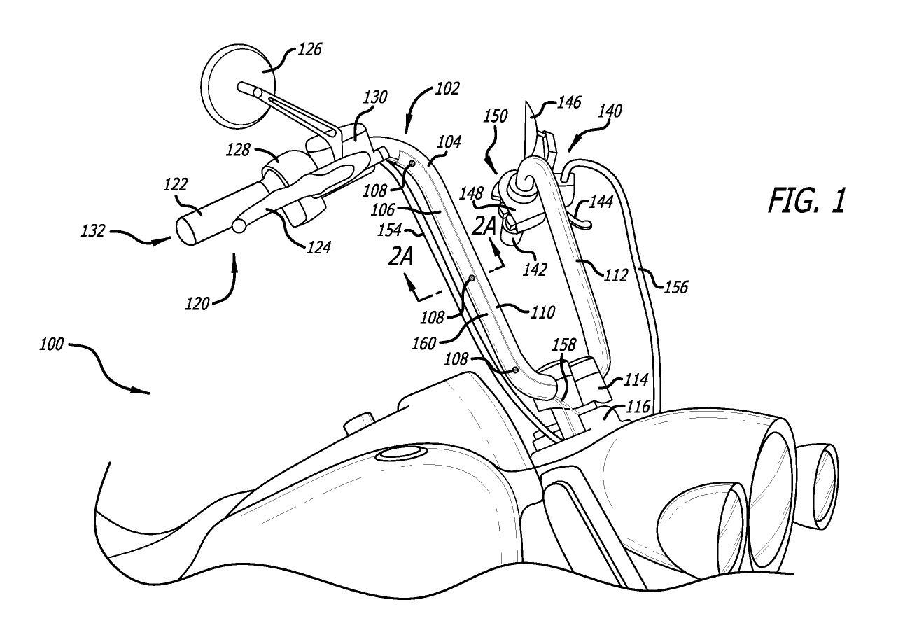

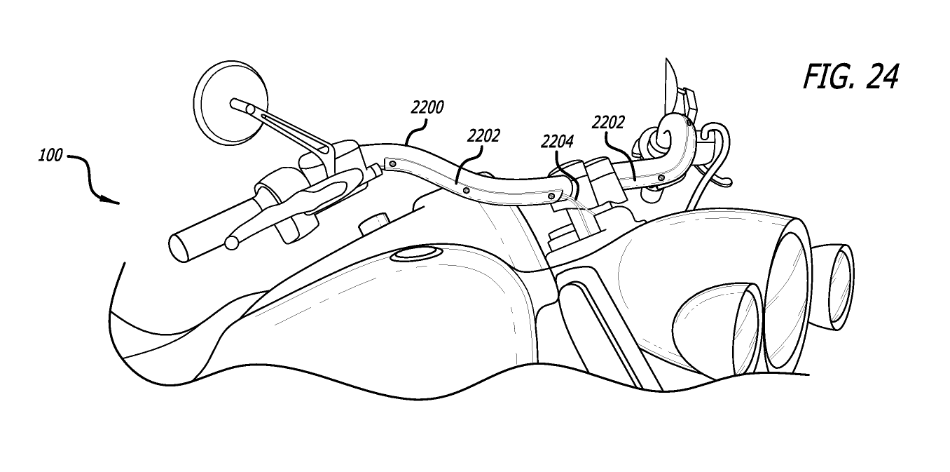

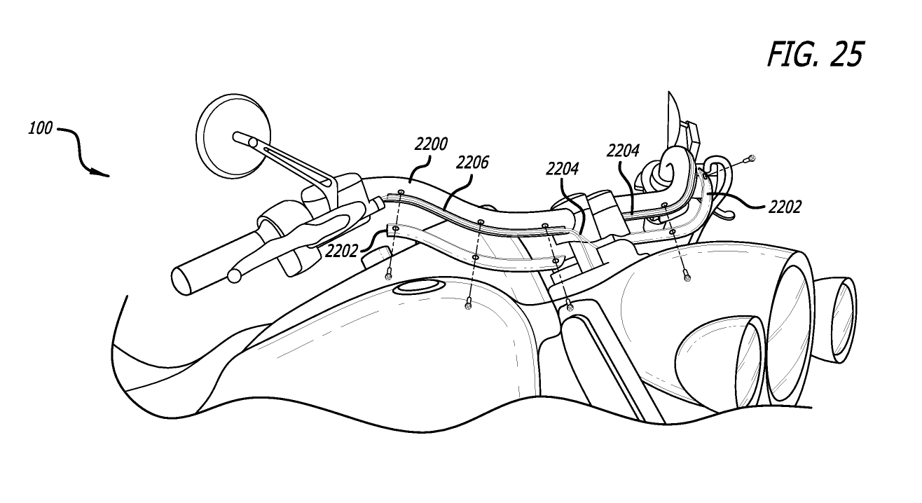

FIGS. 1-24 illustrate various implementations of a motorcycle handlebar assembly of the present invention. The assembly may include a handlebar having one or more wiring channels formed along an outer surface of the handlebar. The channels may be adapted to receive and retain electrical wiring routed from the motorcycle switches to the triple tree. One or more protective coverings may be positioned over the channels and attached to the outer surface of the handlebar by fasteners to protect and retain the electrical wiring within the wiring channels.

FIG. 1 illustrates a motorcycle 100 including one example of one implementation of a handlebar assembly 102 of the present invention. The assembly 102, in the example shown, includes a handlebar 104 and one or more protective coverings or shields 106 extending along at least a portion of the handlebar 104. The protective shields 106 may be detachably secured to the handlebar 104 by fasteners 108 positioned along opposite ends of the shields.

As illustrated, the handlebar 104 may include a tubular member bent to form a right bar member 110, a left bar member 112, and a straight center bar member (partially covered) that mounts to a riser clamp 114 connected to a triple tree 116 assembly of the motorcycle 100. The handlebar 104 may generally be constructed from hollow metal tubing of, for example, aluminum alloy, chrome plated steel, stainless steel, carbon fiber, titanium, or any other suitable material.

Equipment and accessories (generally designated by 120) such as, for example, a throttle 122, a clutch lever 124, a rear-view mirror 126, switches 128, and a master cylinder 130 may be coupled to a grip end 132 of the right bar member 110. Similarly, equipment and accessories (generally designated by 140) such as, for example, a grip 142, a brake lever 144, a rear-view mirror 146, and switches 148 may be coupled to a grip end 150 of the left bar 112.

As shown, a clutch cable 154 may be coupled between clutch lever 124 and engine clutch. Similarly, a brake cable 156 may be coupled between clutch lever 124 and brake assembly. In addition, electrical wiring 158 may be coupled between the switches 128, 148 and one or more control units generally located beneath the fuel tank.

As illustrated, the protective shields 106 may include an elongated slender body 160 configured to complement the size and shape of a respective bar member 110, 112. The protective shields 106 may generally be constructed of a formable material made of plastic, graphite, ceramic, metal such as aluminum or stainless steel, rubber, wood, or any other suitable material.

The protective shields 106 are adapted to be removably attached to portions of the handlebar 104. As will be described in further detail below, the protective shields 106, together with one or more open-ended channels (not shown) formed along respective members of the handlebar 104 define a passage for routing the electrical wiring 156 between the switches 128, 448 to the one or more control units control units generally located beneath the fuel tank.

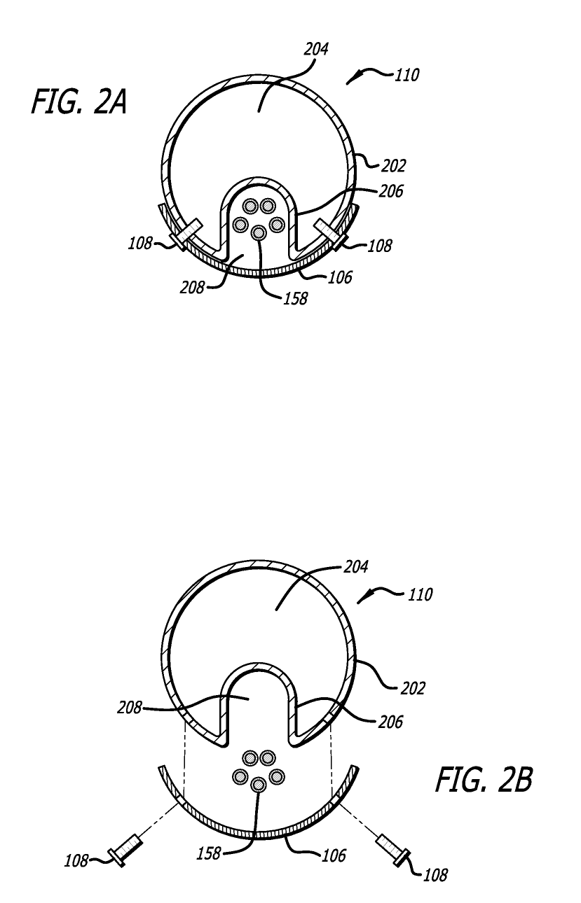

FIGS. 2A and 2B are cross-sectional views of the right bar member 110. FIG. 2A is a cross-sectional view of the right bar member 110 taken along line 2A-2A of FIG. 1. FIG. 2B is an exploded view of the right bar member 110 of FIG. 2A. In this example, the cross-section of the right bar 110 mirrors the cross-section of the left bar member 112. As shown, the bar 110 may be a hollowed tube having an outer diameter 202, an interior 204, and an open-ended wiring channel 206 inwardly extending from the outer diameter 202 into the interior 204. The channel 206 may include a U-shaped cross-section or any other suitable geometry.

In this example, the protective shield 106 is removably attached to the outer diameter 202 of the handlebars by fasteners 108. In other implementations, the protective shields 106 may be attached to the outer diameter by other means such as, for example, an adhesive, press fit, weldment, or any other suitable means. In other implementations, the protective shields 106 may include slideable cover plates adapted to slide in-and-out of slots formed along opposing sides of the wiring channel 206.

As shown, the protective shield 106 may include an arcuate cross-section that conforms to the radial dimensions of the outer diameter 202. When attached to the handlebars, the protective shield 106 encloses channel 206 to form a passage 208 for routing electrical wiring 158 between the switches 128, 148 (FIG. 1) and one or more control units generally located beneath the fuel tank. The shields 106 are adapted to protect and retain the electrical wiring 258 within the channels 206. The channels 206, together with the protective shields 106, provide a non-intrusive means for running electrical wiring along the handlebar assembly 102 (FIG. 1).

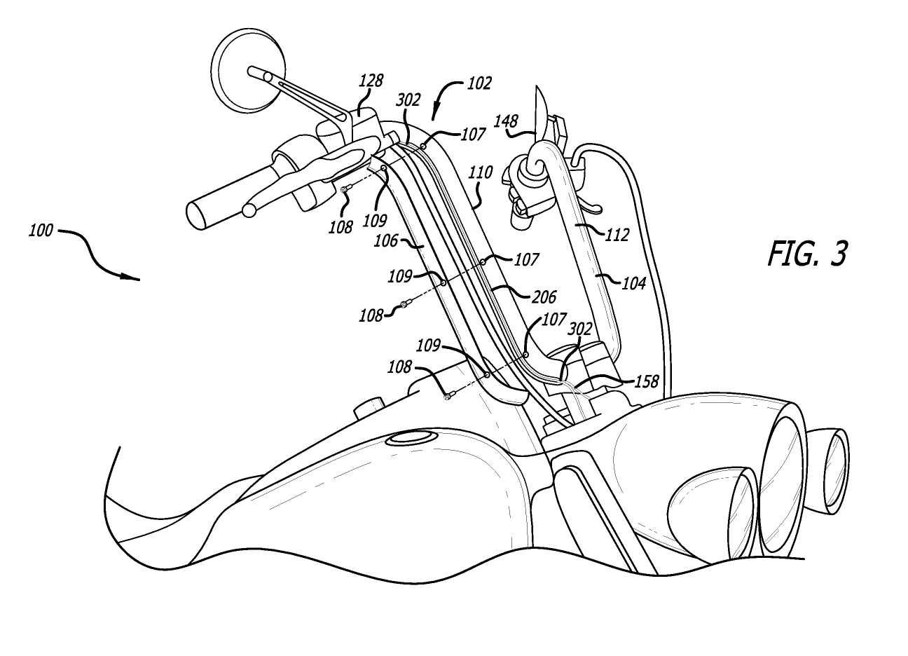

FIG. 3 is another illustration of the motorcycle 100 including one example of an implementation of a handlebar assembly 102 of the present invention. This figure illustrates how the protective shields 106 may be attached to portions of the handlebar members 110, 112 by fasteners 108 engaging corresponding screw holes 107 positioned along the handlebar members 110, 112. The fasteners 108 may engage the screw holes 107 via a series of corresponding fastener holes 109 disposed along the protective shield.

This figure also illustrates how the channels 206 may be dimpled or otherwise formed in the handlebar members 110, 112 from, for example, a portion of the handlebar proximal the switches 128, 148 to a portion of the handlebar proximal the riser clamp 114. While it may be desired to extend ends 302 of the channel 206 as close as possible to the switches and riser clamp, there should be adequate spacing between the ends 302 of the channel 206 and the switches and riser clamp to prevent pinching of the electrical wiring 158, for example when a driver turns the handlebar, at the ends 302 where the wiring exits the wire passage 208.

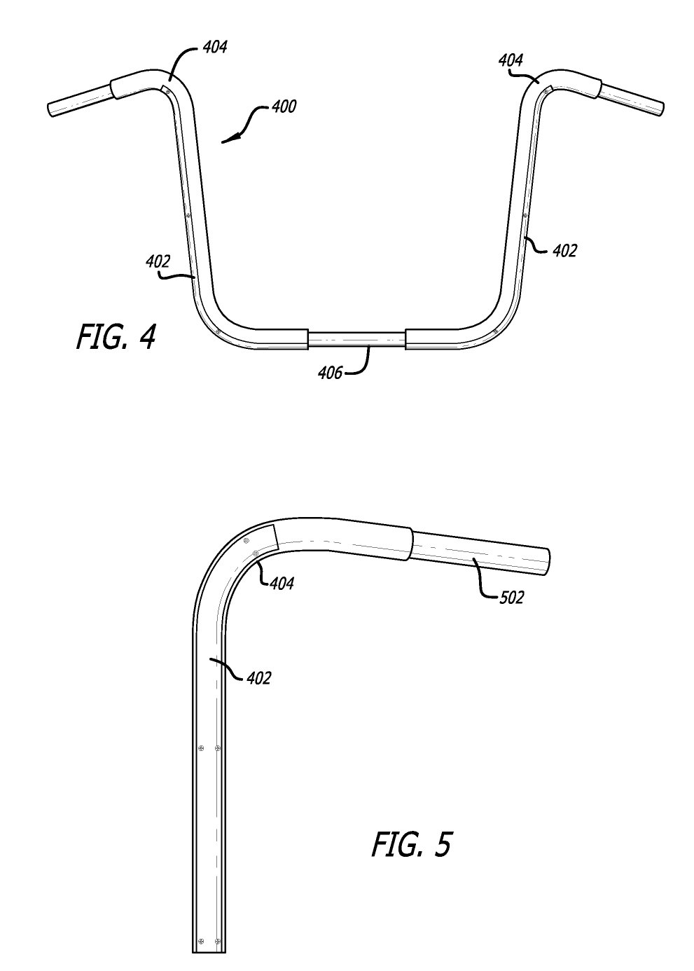

FIG. 4 illustrates an ape hanger style handlebar 400 assembled with one example of an implementation of protective shields 402 of the present invention. In this example, the protective shields 402 may extend from a distal bend 404 to a reduced diameter portion of the center bar 406 where the handlebar mounts to the riser clamp. As better shown in FIG. 5, the protective shield 402 may extend from a distal bend 404 proximal the handlebar grip tube 502.

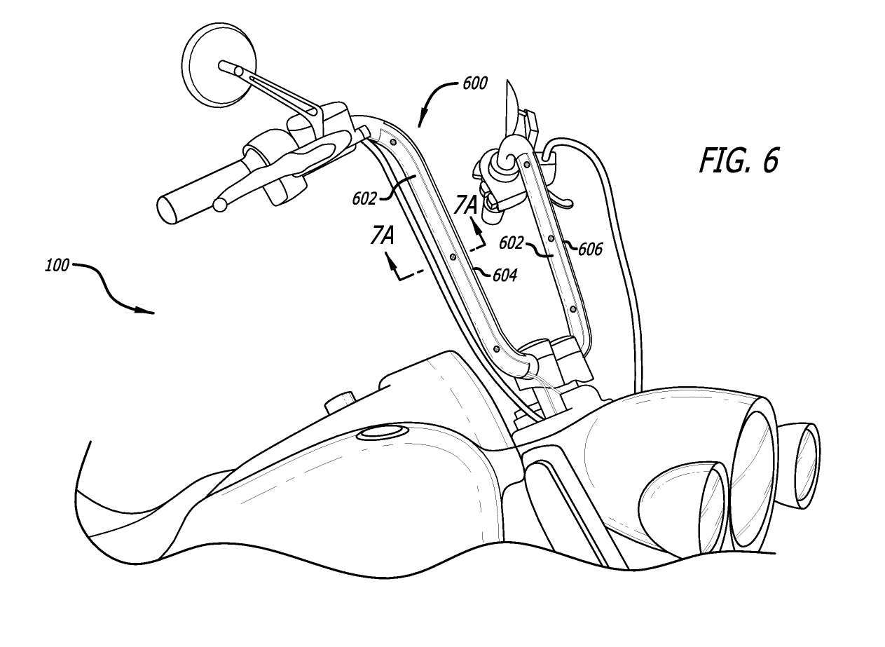

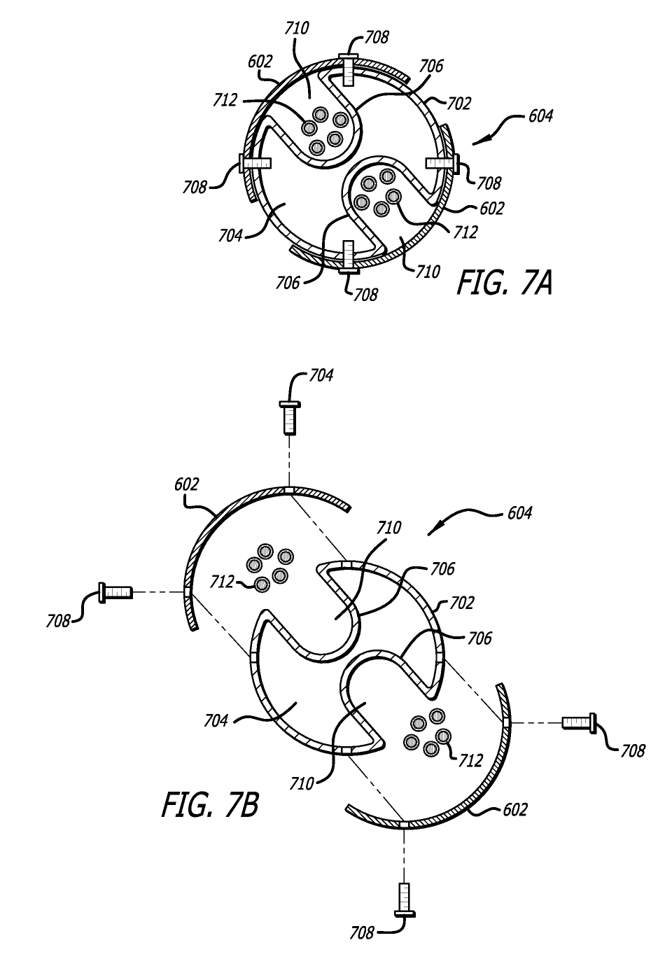

FIG. 6 is another illustration of the motorcycle 100 including one example of one implementation of a handlebar assembly 600 having a pair of protective shields 602, each attached to an opposite side of the handlebar members 604, 606. As shown in the cross-sectional views of FIGS. 7A and 7B, the handlebar members 604, 606 may be a hollowed tube having an outer diameter 702, an interior 704, and a pair of diametrically opposed open-ended channels 706 inwardly extending from the outer diameter 702 into the interior 704.

In this example, the protective shields 602 are removably attached to the outer diameter 702 of the handlebar members 604, 606 by fasteners 708. In other implementations, the protective shields 602 may be attached to the outer diameter by other means such as, for example, an adhesive, press fit, weldment, or any other suitable means. In other implementations, the protective shields 602 may include slideable cover plates adapted to slide in-and-out of slots formed along opposing sides of the wiring channels 706.

As shown, the protective shields 602 may each include an arcuate cross-section that conforms to the radial dimensions of the outer diameter 702. When attached to the handlebars, the protective shields 102 enclose the channels 706 to define a pair of passages 710 for routing electrical wiring 712 between the switches 128, 148 (FIG. 1) and one or more control units generally located beneath the fuel tank. Similar to the example implementation above, the shields 602 are adapted to protect and retain the electrical wiring 712 within the channels 706. In this way, the channels 706, together with the protective shields 602 provide a non-intrusive means for running electrical wiring along the handlebar assembly 102 (FIG. 1).

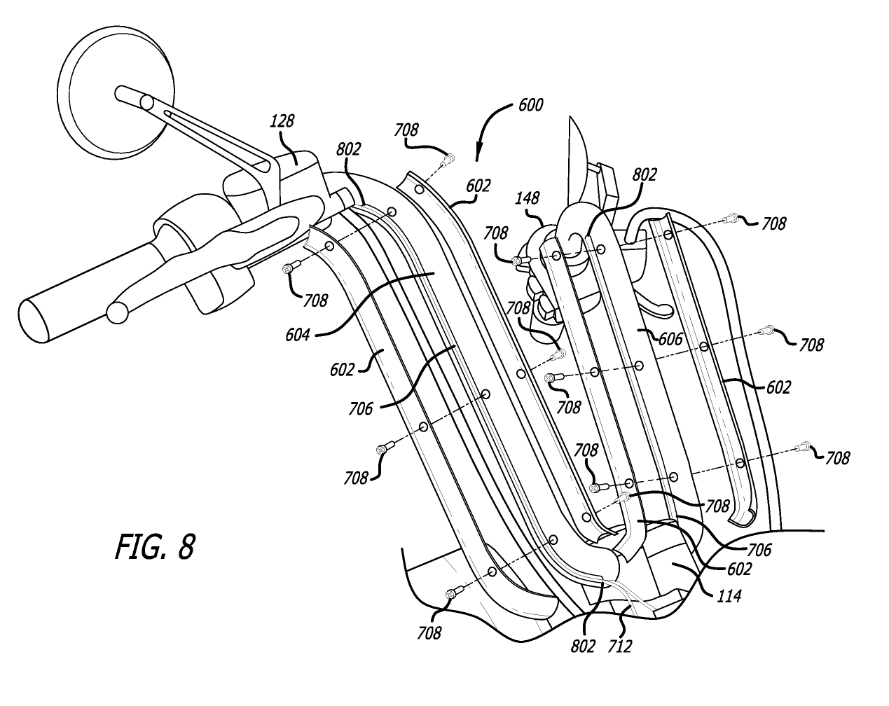

FIG. 8 illustrates how the protective shields 702 may be attached to opposing sides of the handlebar members 604, 606 by fasteners 708. This figure also illustrates how the channels 706 may be dimpled or otherwise formed along opposing sides of the handlebar members 604, 606 from, for example, a portion of the handlebar proximal the switches 128, 148 to a portion of the handlebar proximal the riser clamp 114. While it may be desired to extend ends 802 of the channels 706 as close as possible to the switches and riser clamp, there should be adequate spacing between the ends 802 of the channels 706 and the switches and riser clamp to prevent pinching of the electrical wiring 712, for example during steering of the handlebar, at the ends 802 where the wiring exits the wire passages 710 (FIG. 7A).

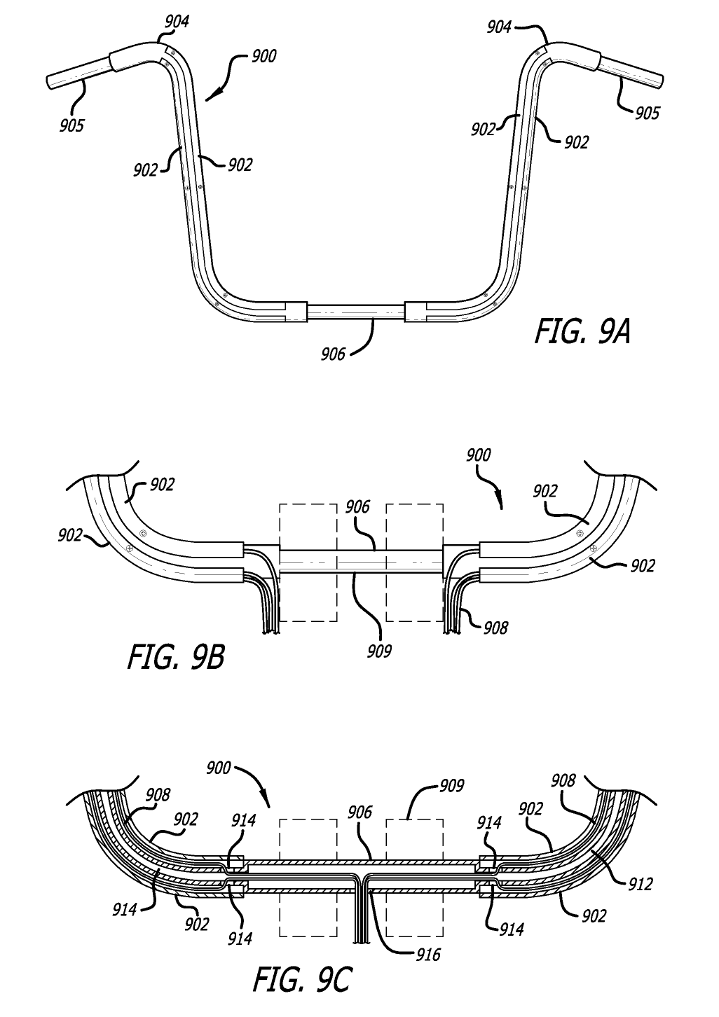

FIG. 9A illustrates an ape hanger style handlebar 900 assembled with a pair of protective shields 902 in accordance with the present invention. In this example, the protective shields 902 may extend from a distal bend 904 to an area proximal a reduced diameter portion of the center bar member 906 where the handlebar mounts to the riser clamp. In other implementations, the protective shields 902 may be extended to the grip tube 905. As shown in FIG. 9B, it may be desirable to extend the length of the protective shields 902 to an area just short of the reduced diameter portion of the center bar 906 to allow electrical wiring 908 to be routed from the handlebar 900 to the triple tree (not shown) outside of the riser clamps 909 (denoted in broken lines) without being pinched or otherwise damaged by the clamp during, for example, steering of the handlebar.

Optionally, as illustrated in FIG. 9C, the electrical wiring 908 may be fed from the wiring channels 910 to the interior 912 of the handlebar 900 through orifices 914 formed near the reduced diameter portion of the center bar member 906. In this example, the electrical wiring 908 may be routed from the handlebar 900 to the triple tree (not shown) through the center of the riser clamps 909 (denoted in broken lines) via an orifice 914 formed in the center of the reduced diameter portion of the center bar member 906.

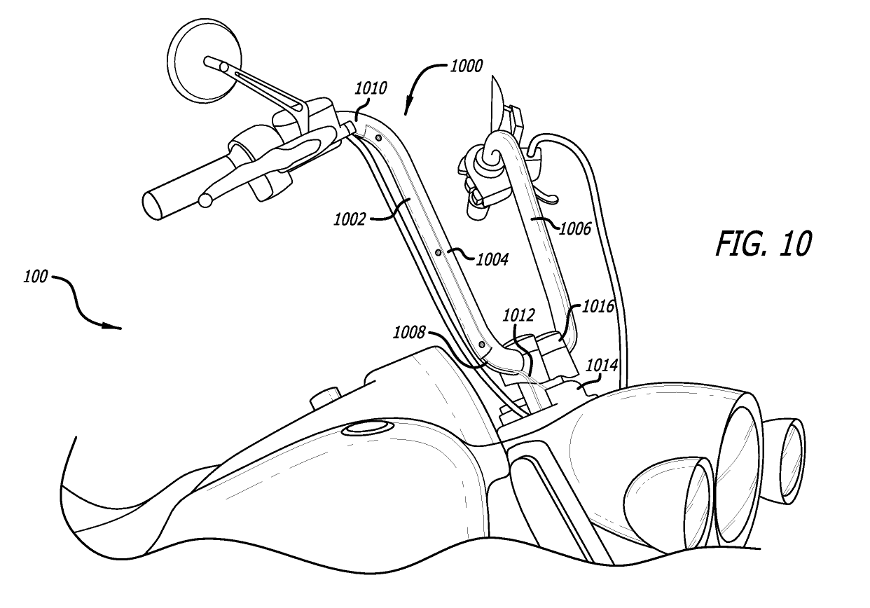

FIG. 10 is another illustration of the motorcycle 100 including another example of an implementation of the handlebar assembly 1000 of the present invention. The handlebar assembly 1000 may include protective shields 1002 attached to handlebar members 1004, 1006. In this example, the protective shields 1002 may only cover a portion of the handlebar members 1004, 1006 extending from a proximal bend 1008 to a distal bend 1010 of the handlebar. In this example, the electrical wiring 1012 may have plenty of spacing between the protective shield 1002 and the rising clamp 1016 to be routed to the triple tree 1014 without being pinched or otherwise damaged by the rising clamp 1016. As an option, the wire ties (not shown) may be with the protective shields 1002 to secure the electrical wiring 1012 to the handlebar members 1004, 1006.

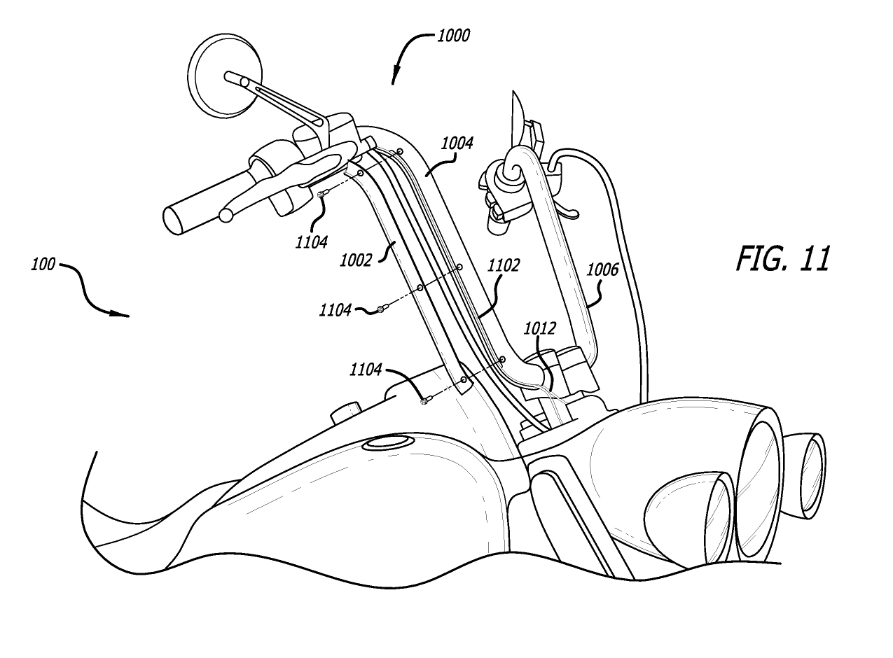

As shown in the FIG. 11, the protective shields 1002 may be positioned over channels 1102 formed along the handlebar members 1004, 1006 for retaining the electrical wiring 1012. The protective shields 1002 may be secured to the handlebar members 1004, 1006 by fasteners 1104.

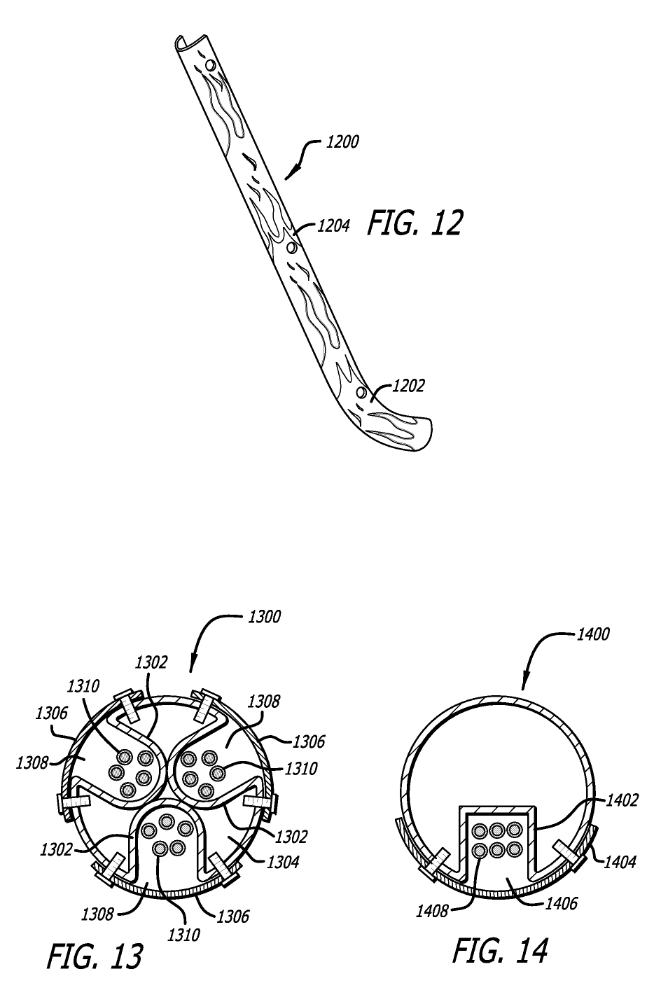

FIG. 12 illustrates one example of an implementation of a decorative protective shield 1200. In this example, the protective shield may include an outer surface 1202 having indicia 1204 imprinted thereon. In this particular example, the indicia may be a graphic design such as, for example, a hot rod flame design. In other implementations, the indicia 1202 may include, for example, logos, coloring, and/or wording.

FIGS. 13 and 14 illustrate cross-sections of alternative implementations of the handlebar in accordance to the present invention. As shown in FIG. 13, the handlebar 1300 may include three open-ended channels 1302 radially arranged in the handlebar interior 1304. In this example, each channel 1302 may be enclosed by a protective shield 1306 to define three passages 1308 for retaining electrical wiring 1310 along portions of the handlebar 1300.

In the alternative, as shown in FIG. 14, the handlebar 1400 may include an open-ended wiring channel 1402 having a substantially square or rectangular cross-section extending into the handlebar interior 1404. In this example, the channel 1402 may be enclosed by a protective shield 1406 that conforms and is secured to an outer surface of the handlebar 1400 to define a substantially square or rectangular passage 1408 for retaining electrical wiring 1410 along portions of the handlebar 1400.

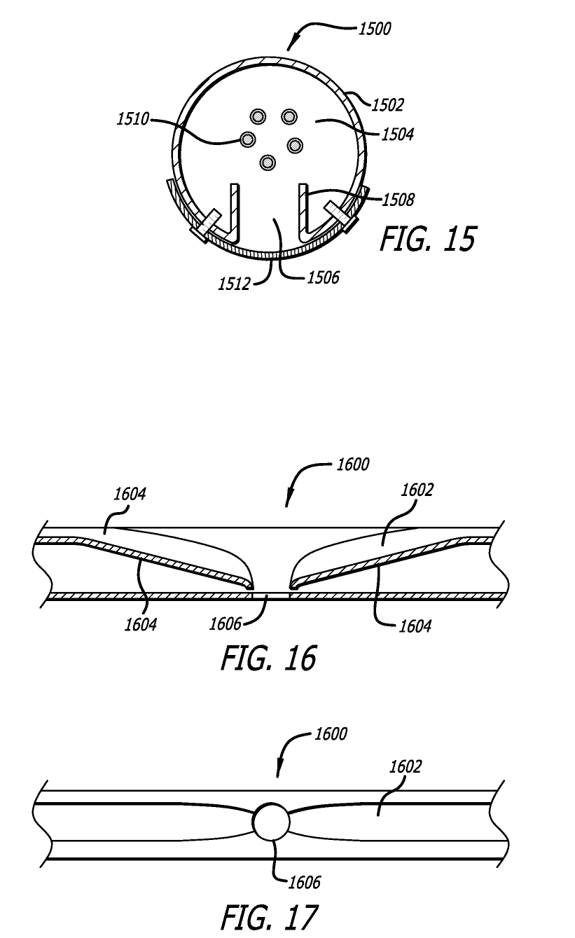

FIG. 15 illustrates the cross-section of yet another implementation of the handlebar in accordance to the present invention. In this example, the handlebar 1500 may include an outer diameter 1502, an interior 1504, and an elongated opening 1506 providing access to the handlebar interior 1504. The opening 1506 may be defined by a pair of tabs 1508 inwardly extending from the outer diameter 1502 into the interior 1504. The tabs 1508 may be capable of the retaining the electrical wiring 1510 within the interior 1504. In the example shown, the tabs 1508 may extend into the interior 1510 substantially parallel to one another. In other implementations, the tabs 1508 may converge toward one another in the interior 1504 to prevent the electrical wiring 1510 from falling or slipping out of the interior 1504.

In the present example, the electrical wiring 1510 may be installed in the handlebar interior 1501 via the opening 1506. Alternatively, the handlebar 1500 may be dimpled at opposite ends of the opening 1506 to enable the electrical wiring 1510 to be threaded into the interior 1504. In this way, the opening 1506 may provide access during installation to grasp and pull the wiring 1510 within the interior 1510.

Once installed in the interior 1504, as shown, a protective shield 1512 may be secured to the outer diameter 1502 by fasteners 1514 or other suitable means to provide a protective covering and retain the electrical wiring 1510 in the interior 1504.

FIGS. 16 and 17 illustrate a partial view of the center bar 1600 of an example handlebar of the present invention. In this example, the wiring channels 1602 may include a taper 1604 near the middle of the center bar 1600 to enable the electrical wiring (not shown) to be dropped or routed from the handlebars to the triple tree thru an orifice 1606 positioned at or near the middle of the center bar 1600.

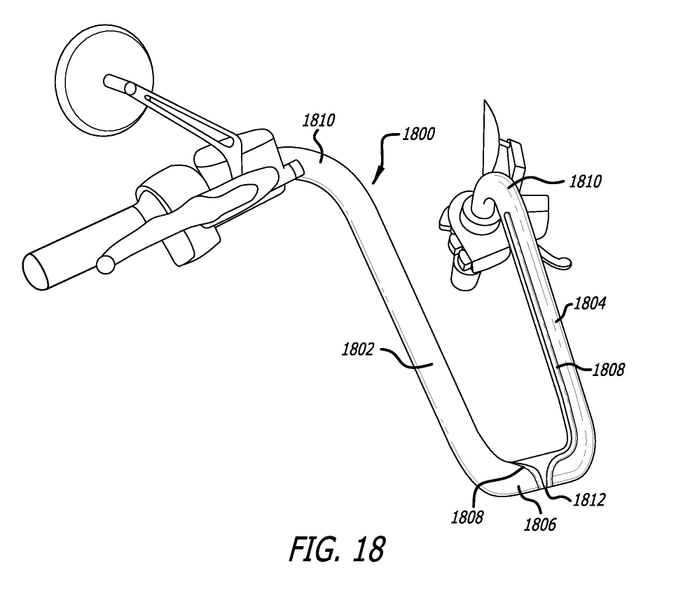

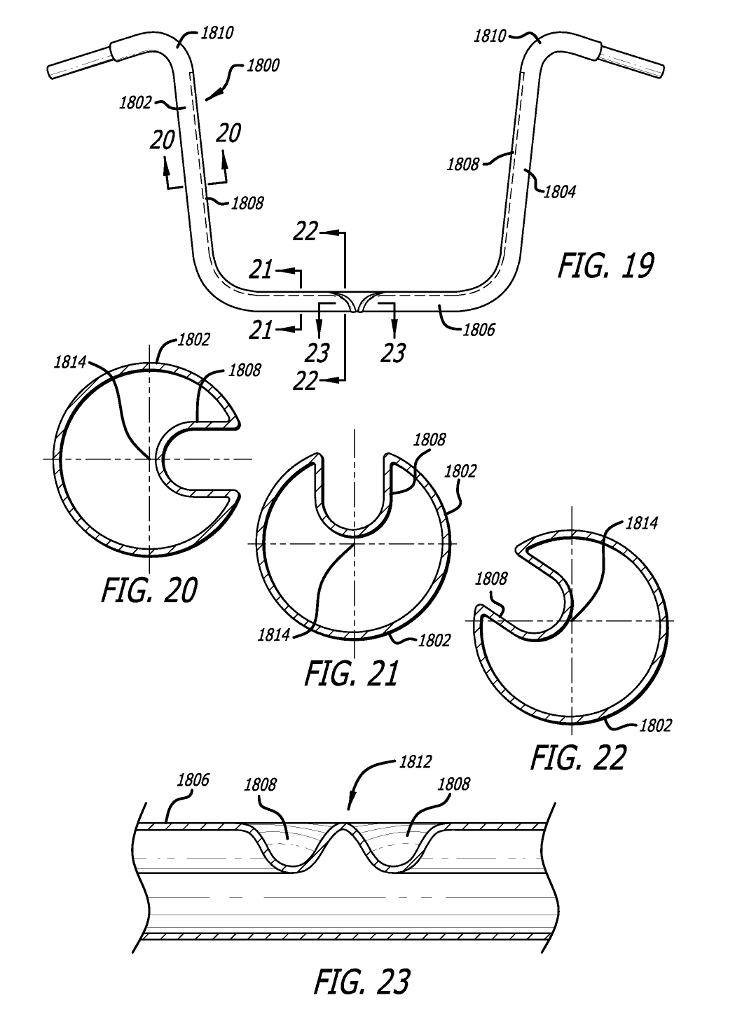

FIGS. 18-23 illustrate various views of another implantation of a handlebar 1800 of the present invention. In this example, as best shown in FIGS. 18 and 19, the handlebar 1800 may include a right handlebar member 1802, a left handlebar member 1804, a center bar member 1806, and wiring channels 1808 extending, for example, from a distal bend 1810 to the center bar member 1806. At the center bar 1808, the channels 1808 may diametrically converge at a region 1812 proximal the middle of the center bar member 1808.

For example, as shown in FIGS. 20-22, the relative radial position of the wiring channel 1808 formed in the right handlebar 1802 may rotate about the centerline axis 1812 of the handlebar about 135° as the channels 1808 are converged in region 1812. In region 1812, the channels 1808 may be adjoined to form an integral pair of channels for routing the electrical wiring from the handlebar to the triple tree, as shown in FIG. 23.

FIGS. 22 and 23 illustrate another example of protective shields 2202 of the present invention assembled on a cruiser style handlebar 2200. In this example, the protective shields 2202 may be secured to the handlebar 2200 to retain electrical wiring 2204 disposed in wiring channels 2206 (FIG. 23) formed along the underside of the handlebar 2200.

Persons skilled in the art will appreciate that the wiring channels constructed in handlebars of present invention may be formed by various means. For example the channels may be formed by casting, machining, laser machining, or any other suitable means.

While the example implementations illustrated herein describe only a single wiring channel formed along a side of the handlebar member, two or more wiring channels may be formed along a side of the handlebar members without deviating from the spirit and/or scope of the present invention. Similarly, while the example implementations illustrated herein describe only a single protective shield attached to the outer surface of each handlebar member, two or more protective shields may be secured to each handlebar member without deviating from the spirit and/or scope of the present invention.

Further, while the example implementations described herein apply to motorcycles handlebars, persons skilled in the art will appreciate that handlebar assemblies of the present invention may also apply to steering mechanisms for other mobile vehicles having electronics including bicycles, all-terrain vehicles (ATVs), snowmobiles, watercrafts, and other mobile vehicles. Handlebar assemblies of the present invention may also apply to various styles of handlebars, including, for example, mini and tall ape hangers, beach bars, cruiser bars, drag bars, clubman bars, clip-ons, wishbone, buckhorn, and Z-bars. Handlebars of the present invention are described herein as including tubular members, but persons skilled in the art will appreciate that handlebars of the present invention may also be constructed of other cross-sectional geometries including, for example, square, rectangular, polygonal, or any other desired geometry. In addition, while the example implementations disclosed herein describe electrical wiring being routed through the handlebar channels, persons skilled in the art will appreciate that clutch and/or brake cabling may also be routed through handlebar channels of the present invention.

In general, terms such as “coupled to,” and “configured for coupling to” and “secured to” (for example, a first component is “coupled to” or “is configured for coupling to” or is “secured to” a second component) are used herein to indicate a structural, functional, mechanical, electrical, signal, optical, magnetic, electromagnetic, ionic or fluidic relationship between two or more components or elements. As such, the fact that one component is said to couple to a second component is not intended to exclude the possibility that additional components may be present between, and/or operatively associated or engaged with, the first and second components.

Although the previous description only illustrates particular examples of various implementations, the invention is not limited to the foregoing illustrative examples. A person skilled in the art is aware that the invention as defined by the appended claims can be applied in various further implementations and modifications. In particular, a combination of the various features of the described implementations is possible, as far as these features are not in contradiction with each other. Accordingly, the foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A handlebar assembly comprising:
a tubular member having an outer diameter, an interior, and a channel extending axially along at least a portion of the member, the channel extending inward from the outer diameter to the interior; and
a protective covering detachably coupled to the outer diameter where the protective covering is positioned over the channel and configured to conform to the outer diameter, the protective covering cooperating with the channel to define a passage for routing electrical wiring therein.

2. The handlebar assembly of claim 1 where the tubular member is bent to form a right member, left member, and a center member.

3. The handlebar assembly of claim 2 where the channel extends axially along the right and left members.

4. The handlebar assembly of claim 2 where the channel extends axially along the right, left member, and center members.

5. The handlebar assembly of claim 1 where the protective covering is coupled to the outer diameter by fasteners.

6. The handlebar assembly of claim 1 where the protective covering is coupled to the outer diameter by a weldment.

7. The handlebar assembly of claim 1 where the protective covering includes a slideable cover plate adapted to slide in-and-out of slots formed along opposing sides of the channel

8. The handlebar assembly of claim 1 where the tubular members comprises two or more channels extending inward from the outer diameter to the interior.

9. The handlebar assembly of claim 8 further comprising a protective covering positioned over each channel where the protective covering is detachably coupled to and configured to conform to the outer diameter, the protective covering cooperating with each channel to define a passage for routing electrical wiring therein.

10. Handlebars for a mobile vehicle comprising:
a hollow tubular member having an outer diameter and an interior; and
a channel inwardly extending from the outer diameter into the interior, where the channel is formed along at least a portion of the tubular member.

11. The handlebars of claim 10 where the tubular member is bent to form a right member, left member, and a center member.

12. The handlebars of claim 11 where the channel extends axially along the right and left members.

13. The handlebars of claim 11 where the channel extends axially along the right, left member, and center members.

14. The handlebars of claim 10 where a protective covering is positioned over the channel, the protective covering being detachably coupled to the outer diameter and cooperating with the channel to define a passage for routing electrical wiring therein.

15. The handlebars of claim 10 where the tubular member comprises two or more channels extending inward from the outer diameter to the interior.

16. A protective covering for a handlebar having at least one channel formed along an outer surface of handlebar, the protective covering comprising an elongated slender body having an arcuate cross-section that conforms to outer surface of the handlebar, the protective covering being positioned over the at least one channel and detachably coupled to the outer surface.

17. The protective covering of claim 16 further comprising a plurality of screw holes for receiving fasteners that secure the protective covering to the handlebars.

18. The protective covering of claim 17 where the protective covering is permanently secured to the outer surface.

19. The protective covering of claim 16 further comprising indicia imprinted thereon.
